(19) United States
(12) Patent Application Publication
(10) Pub. No.: US 2023/0191291 A1
(43) Pub. Date: Jun. 22, 2023

(54) Textured Substrate Filter For Removal Of Particulates From Fluid

(71) Applicant: Mincon, Inc., Roanoke, VA (US)

(72) Inventor: Simon DUCK, Monroe, NC (US)

(73) Assignee: Mincon, Inc., Roanoke, VA (US)

(21) Appl. No.: 17/558,700

(22) Filed: Dec. 22, 2021

(51) Int. Cl. B01D 29/44; B01D 39/16

(52) U.S. Cl. CPC B01D 29/44; B01D 39/16

(57) ABSTRACT

A device and method providing a textured substrate member and filtration device. The filtration device has a substrate member with a textured surface and a uniform surface on a side opposite the textured surface. The textured surface includes protrusions configured to interfere with a liquid flow traversing the textured surface to remove particulates entrained in the liquid flow. When the substrate member is disposed beneath a liquid source directed over the textured surface, the textured substrate forms a gravity-fed liquid filtration system. Also, a method for filtering particulates from a liquid includes providing a substrate member having a textured surface and a uniform surface opposite the textured surface; the textured surface having protrusions; configuring the plurality of protrusions to interfere with a liquid flow traversing the textured surface and remove particulates entrained in the liquid flow; and disposing the substrate member beneath the liquid flow.

### BACKGROUND

The application generally relates to filter media substrates. The application relates more specifically to method for removal of particulates from fluid using a textured substrate.

Currently, there are a number of solutions for removing particulates from fluids. Some of these solutions attempt to use filter media with permeable membranes to remove particulates, but these solutions fail to meet the needs of the industry because they require a higher pressure differential, clog quickly, need regular replacement, have a high cost and are not energy efficient. Other solutions attempt to use flocculants but these solutions fail to meet the needs of the industry because they have a high cost and cannot be effectively utilized for, but not limited to, drilling, construction and environmental applications. Other solutions attempt to use centrifuges by creating a single vortex to remove particulates, but these solutions are similarly unable to meet the needs of the industry because of a high degree of technology and expertise required, energy inefficiency, high cost of operation, safety issues and are unable to remove large particulates for industrial applications.

It is desirable to have a device that can effectively and rapidly remove particulates from liquid, especially water, of 150 microns or lower without using traditional, consumable permeable filter mesh or media which quickly clogs and adds high expense for earth drilling technology where clean fluid, including water, is required. Furthermore, it would also be desirable to have a device that produces cleaned fluids for environmental drilling applications. Still further, it would also be desirable to have a device that can filter fluids without requiring fluid pressure to push a fluid through a membrane which is energy inefficient. Still further, it would also be desirable to have a device that cost-effectively removes particulates of 150 microns or lower to allow construction, environmental and waste water to meet local law requirements and be discharged into municipality sewers. The disclosed device and associated method advantageously fill these need and addresses the aforementioned deficiencies by providing a particulate filtration substrate that does not require replacement unlike typical liquid filter medias and does not require pressurization of the fluid to be filtered increasing safety.

What is needed is a system and/or method that satisfies one or more of these needs or provides other advantageous features. Other features and advantages will be made apparent from the present specification. The teachings disclosed extend to those embodiments that fall within the scope of the claims, regardless of whether they accomplish one or more of the aforementioned needs.

### SUMMARY

One embodiment relates to a substrate for removal of particulates from a liquid flow, comprising: a substrate member having a textured surface; the textured surface comprising a plurality of protrusions; the protrusions configured to interfere with a liquid flow traversing the textured surface and remove particulates entrained in the liquid flow.

Another embodiment relates to a filtration device comprising a substrate member having a textured surface and a uniform surface opposite the textured surface; the textured surface comprising a plurality of protrusions; the protrusions configured to interfere with a liquid flow traversing the textured surface to remove particulates entrained in the liquid flow; wherein when the substrate member is disposed beneath a liquid source directed over the textured surface forms a gravity-fed liquid filtration system.

Another embodiment relates to a method for filtering particulates from a liquid comprising: providing a substrate member having a textured surface and a uniform surface opposite the textured surface; the textured surface comprising a plurality of protrusions; configuring the plurality of protrusions to interfere with a liquid flow traversing the textured surface and remove particulates entrained in the liquid flow; disposing the substrate member beneath a liquid source to receive the liquid flow.

Certain advantages of the embodiments described herein are a textured substrate for the removal of particulates from fluids.

The novel disclosed device allows for the filtration of particulate matter from a liquid stream by allowing liquid, e.g., water, to pass over it instead of through it, unlike typical permeable filter membranes that require constant replacement.

Similarly, the disclosed novel device may easily be completely cleaned and reused without removal from the filtration system. Another advantage is that the filter member is environmentally friendly as no permeable membranes are used, replaced or discarded.

The disclosed method may be effectively utilized to remove various sized particulates from liquids across industries and applications. Similarly, the disclosed method is unique when compared with other known processes and solutions in that it: (1) pressure is not required to push the liquid through a membrane and therefore requires less energy to operate; (2) the textured substrate filter does not require replacement and can be cleaned in situ; and (3) the basic filtration system can be operated manually without the need for powered systems.

The novel filter member is structurally distinguishable from other known filtration devices or solutions. More specifically, the device is unique as it is; (1) a nonpermeable single surfaced filter substrate allowing liquid to pass over it, not through it; (2) only the exterior of the substrate becomes soiled and is easily completely cleaned; (3) it can be made from almost any material, depending on the application, making it more environmentally friendly and (4) the substrate can be printed using renewable materials.

Furthermore, the process associated with the aforementioned device is likewise unique. More specifically, the disclosed process owes its uniqueness to the fact that it (1) uses gravity to feed liquid over a filtration substrate to trap particulates and no liquid pressure is required to push liquid through a membrane increasing safety; (2) particulates are filtered by the substrates surface as fluid flows over it, not through it; and (3) the substrate can be cleaned in use without removal from the application, increasing efficiency and lowering cost over traditional filter medias.

Alternative exemplary embodiments relate to other features and combinations of features as may be generally recited in the claims.

### BRIEF DESCRIPTION OF THE FIGURES

The application will become more fully understood from the following detailed description, taken in conjunction with the accompanying figures, wherein like reference numerals refer to like elements, in which:

FIG. 1 shows an exemplary embodiment of a single surface textured substrate of the present invention.

FIG. 2 is an elevational view of the substrate of FIG. 1, taken along lines 2-2.

FIG. 3 is perspective view of the substrate of FIG. 1.

FIG. 4 is a cross-sectional view of the substrate taken along lines 4-4 of FIG. 3.

FIG. 5 is an enlarged detail view of the substrate indicated by section A of FIG. 3.

### DETAILED DESCRIPTION OF THE EXEMPLARY EMBODIMENTS

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

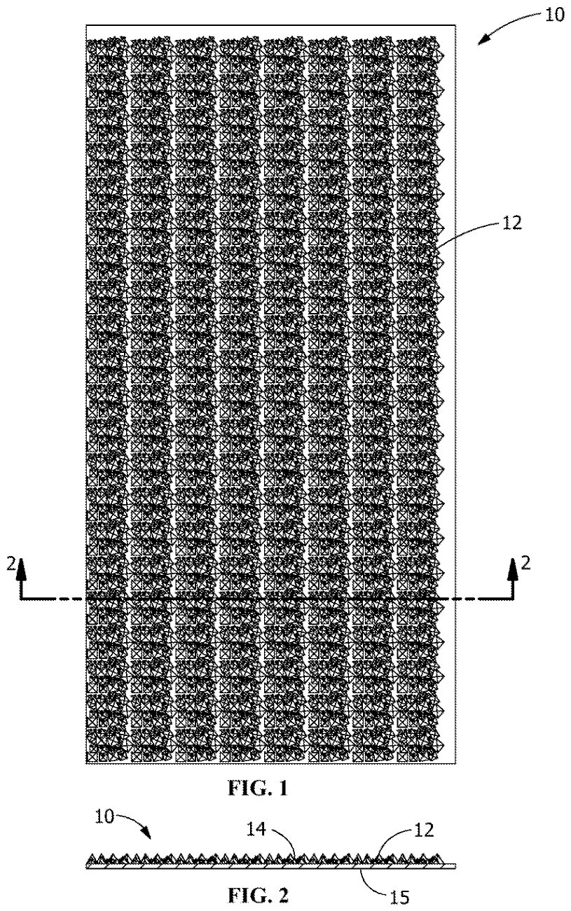

Referring to FIG. 1, a single-surface textured substrate member 10 has a textured surface 12. Substrate member 10 may be provided in the form of a mat, a sheet or a belt with textured surface 12 including raised geometric protrusions 14 (FIG. 2). Protrusions 14 may be formed in varying shapes and sizes, as described in greater detail below. Protrusions 14 may be formed from various materials, e.g., stereolithography materials (epoxy resins), metal, elastomers, rubber, polymers, or silicone. A uniform surface 15 of substrate member 10 is disposed opposite textured surface 12. Uniform surface 15 may be smooth, e.g., for a rigid substrate, or have a frictional surface for better adhesion to an external surface.

In operation substrate member 10 is disposed beneath a liquid source 18 on a declining angle, whereby liquid flowing from source 18, indicated by arrows, is directed over textured surface 12. Liquid flows over the substrate member 10, e.g., a mat, to form a gravity-fed liquid filtration system. Substrate member 10 may include a rounded texture substrate (not shown) for the removal of specific and various particulates; a pyramidal texture substrate for the removal of specific and various particulates; any geometry texture substrate (FIG. 5) for the removal of specific particulates; or a combination of geometries making up the textured surface.

In an embodiment, substrate member 10 may include a textured surface 12 having a combination of various sized geometries. Alternately, substrate member 10 may include a textured surface 12 having a uniformed size geometric element 16 may include a textured surface 12 having a symmetrical pattern. In another embodiment, textured surface may have geometric elements arranged in a random pattern.

Referring next to FIG. 2, an elevational cross-section of the substrate 10 shown the textured surface 12 on the top side of the substrate and the uniform surface 15 opposite the textured surface. Geometric protrusions 14 projecting upward provide the texture for textured surface 12, and generates turbulence in flowing liquid 18 to filter particulates that may be entrained in the liquid source.

Referring next to FIG. 3 a perspective view of the substrate of FIG. 1, shows a sloping arrangement of substrate member 10, with liquid flow 18 across textured surface 12.

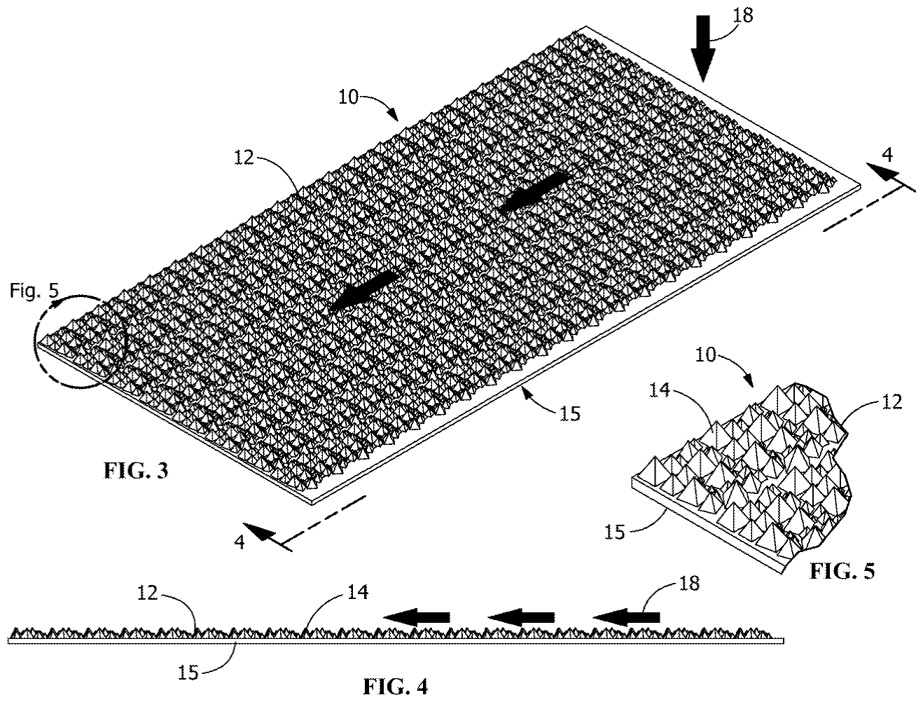

Referring next to FIG. 4 a side elevational view of the substrate 10 taken along lines 4-4 of FIG. 3. The flow 18 traverses geometric protrusions 14 on surface 12. The smooth bottom surface 15 is not exposed to liquid flow, and may be in frictional contact with a base or underlayment to secure substrate 10 in position.

Referring next to FIG. 5 is an enlarged detail view of the substrate indicated by circle A of FIG. 3. In the embodiment of FIG. 5 geometric protrusions 14 are pyramidal, and differ in size to enhance the irregularity of textured surface 12, thereby generating a desired level of turbulence in liquid flow 18.

The disclosed embodiments show a uniform surface opposite the textured surface in a preferred embodiment. In an alternate embodiment, both surfaces of the substrate may include a textured surface. The opposing surfaces may have the same configurations, or may have different texture configurations.

A method of filtering particulates using the textured substrate member 10 is also disclosed. Substrate member 10 may be arranged in a series of additional lengths or sections. Substrate member 10 may be a flexible mat, a rigid sheet, or a continuous belt, whichever is suitable for the application, to maximize particulate removal from the liquid stream.

In another embodiment, a series of textured substrate mats, sheets or belts 10 may be placed above one another to create a cascading flow of fluid to maximize filtration, e.g., in an application where space is limited. In another embodiment textured substrate member 10 may be arranged with varying degrees of decline to accommodate the viscosity of the fluid being filtered, or to maximize filtration of the fluid as required by the application. Substrate member 10 may be used in combination with other conventional filtration methods as required by the application.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the single-surface textured substrate as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application.

What is claimed is:

1. A substrate for removal of particulates from a liquid flow, comprising:
a substrate member having a textured surface;
the textured surface comprising a plurality of protrusions;
the protrusions configured to interfere with a liquid flow traversing the textured surface and remove particulates entrained in the liquid flow.

2. The substrate of claim 1, wherein the substrate member comprises one of: a mat, a sheet or a belt.

3. The substrate of claim 2, wherein the plurality of protrusions comprise one or more geometric shapes.

4. The substrate of claim 3, wherein the geometric shapes are pyramidal.

5. The substrate of claim 3, wherein the geometric shapes are rounded.

6. The substrate of claim 3, wherein the geometric shapes are a combination of pyramidal, rounded, and variable shapes.

7. The substrate of claim 3, wherein the geometric shapes are comprised of different sizes.

8. The substrate of claim 4, wherein the protrusions are comprised of material selected from the group of stereolithography materials, metal, elastomers, rubber, polymers, silicone, and combinations thereof.

9. The substrate of claim 5, wherein the stereolithography materials are comprised of epoxy resins.

10. The substrate of claim 1, wherein the substrate member is rigid and the uniform surface is smooth.

11. The substrate of claim 1, wherein the uniform surface is a frictional surface for better adhesion to an external surface.

12. A filtration device comprising a substrate member having a textured surface and a uniform surface opposite the textured surface;
the textured surface comprising a plurality of protrusions;
the protrusions configured to interfere with a liquid flow traversing the textured surface to remove particulates entrained in the liquid flow; wherein
when the substrate member is disposed beneath a liquid source directed over the textured surface forms a gravity-fed liquid filtration system.

13. The filtration device of claim 12, wherein the substrate member comprises a rounded texture substrate for the removal of specific and various particulates

14. The filtration device of claim 12, wherein the substrate member comprises a pyramidal texture substrate for the removal of specific and various particulate.

15. The filtration device of claim 12, wherein the substrate member comprises a mat, the mat disposed on a declining angle relative to the liquid flow.

16. A method for filtering particulates from a liquid comprising:
providing a substrate member having a textured surface and a uniform surface opposite the textured surface; the textured surface comprising a plurality of protrusions;
configuring the plurality of protrusions to interfere with a liquid flow traversing the textured surface and remove particulates entrained in the liquid flow;
disposing the substrate member beneath a liquid source to receive the liquid flow.

17. The method of claim 16, further comprising:
arranging a plurality of substrate members in a series of sections to increase removal of particulates from the liquid flow.

18. The method of claim 16, further comprising:
placing a series of textured substrate members mats, in cascading sections above one another to maximize filtration.

19. The method of claim 18, further comprising:
arranging the series of substrate members in varying degrees of decline to accommodate a viscosity of a fluid being filtered in the liquid flow; or to maximize filtration of the fluid as required by the application.

20. The method of claim 16, wherein the method uses gravity to feed liquid over the substrate member to trap particulates and liquid pressure is not required to push liquid through a membrane; particulates in the liquid flow are filtered by the textured surface as a fluid flows over it; and the substrate member is cleaned in use without removal from an application for increasing efficiency and lowering cost.
